(19) United States
(12) Patent Application Publication
(10) Pub. No.: US 2021/0133908 A1
(43) Pub. Date: May 6, 2021

(54) INTEGRATED SOCIAL NETWORKING MOBILE APPLICATION WITH RIDE SHARING PROGRAM

(71) Applicant: 2Manycars Inc., Nashville, TN (US)

(72) Inventor: Jesse Loflin, Nashville, TN (US)

(21) Appl. No.: 17/085,257

(22) Filed: Oct. 30, 2020

Related U.S. Application Data
(60) Provisional application No. 62/927,777, filed on Oct. 30, 2019.

(51) Int. Cl. G06Q 50/30; G06Q 30/02; G06Q 30/00; G06Q 50/00; G06Q 10/02; G01C 21/34

(52) U.S. Cl. CPC G06Q 50/30; G06Q 30/0284; G06Q 30/018; G06Q 50/01; G06Q 20/085; G01C 21/3438; G01C 21/3469; G06Q 2240/00; G06Q 10/02

(57) ABSTRACT

A method may include receiving, over a data network, driver input data from a driver user device, and receiving, over the data network, passenger input data from a passenger user device. The method may include determining that the driver input data and the passenger input data satisfy a predetermined criteria based on, at least in part, a driver destination corresponding to a passenger destination. The method may include calculating an estimated passenger usage amount for the passenger user device and sending first rideshare data to the driver user device. The method may include receiving selection data from the driver user device. The selection data may include data indicating a selection of the passenger user device. The method may include sending ride proposal data to the passenger user device. The method may include receiving acceptance data from the passenger user device and sending second rideshare data to the driver user device.

### CROSS-REFERENCES TO RELATED APPLICATIONS

This non-provisional patent application claims priority to U.S. Provisional Patent Application No. 62/927,777, which was filed on Oct. 30, 2019, and is entitled “Integrated Social Networking Mobile Application with Ride Sharing Program,” which is pending, the entirety of which is incorporated by reference.

### COPYRIGHT NOTICE

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The present disclosure relates generally to mobile software applications, and particularly to an integrated social networking mobile application with a ride sharing program.

Many people drive their personal vehicles to destinations such as work, school, sporting events, or other activities. A large portion of these people drive to these destinations alone. A large number of drivers heading to generally the same area simultaneously creates traffic jams, which can cause wasted time, wasted fuel, and excessive pollution.

While certain ridesharing mobile applications exist, these applications are limited in their functionality and waste computing resources. For example, with conventional rideshare mobile applications, a passenger user uses the mobile application to send a request for a ride to a central server, and the central server broadcasts the request to all driver users of the mobile application near the passenger user. The first driver user to respond to the request is selected by the central server to service the passenger user while the remaining driver users wait for the next broadcast.

This conventional rideshare mobile application includes several disadvantages. First, driver users must wait for a broadcast from the central server, meaning that the driver users are likely driving around the area wasting fuel and constantly checking their mobile devices while driving. Second, when the central server sends out the broadcast, it usually generates a high number of messages to the driver user devices, which uses a lot of computing resources and a lot of network bandwidth to send out all of the messages. Third, several driver users may attempt to respond to the broadcast to accept servicing the passenger user, but only the first response is accepted, meaning that all of the other responses are ignored, which also wastes the central server's computing resources and bandwidth and the computing resources and bandwidth of the driver user devices.

What is needed then are improvements to integrated social networking mobile applications with ride sharing programs.

### BRIEF SUMMARY

This Brief Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect of the disclosure includes a computer-implemented method for a ride-sharing mobile application. The method may include receiving, over a data network, driver input data from a driver user device. The driver input data may include data indicating a driver destination. The method may include receiving, over the data network, passenger input data from a passenger user device. The passenger input data may include data indicating a passenger destination. The method may include determining that the driver input data and the passenger input data satisfy a predetermined criteria based on, at least in part, the driver destination corresponding to the passenger destination. The method may include calculating an estimated passenger usage amount for the passenger user device. The method may include sending, over the data network, first rideshare data to the driver user device. The first rideshare data may include data indicating a location of the passenger user device and data indicating the estimated passenger usage amount. The method may include receiving, over the data network, selection data from the driver user device. The selection data may include data indicating a selection of the passenger user device. The method may include sending, over the data network, ride proposal data to the passenger user device. The ride proposal data may include data indicating the estimated passenger usage amount. The method may include receiving, over the data network, acceptance data from the passenger user device. The acceptance data may include data indicating an acceptance, from the passenger user device, corresponding to the ride proposal data. The method may include sending, over the data network, second rideshare data to the driver user device. The second rideshare data may include data indicating the acceptance from the passenger user device.

In some embodiments, calculating the estimated passenger usage amount may be based on, at least in part, an added distance corresponding to the passenger user device, a fuel-efficiency of a vehicle of a passenger user, or a distance-cost analysis of a route to the driver destination. In one embodiment, calculating the estimated passenger usage amount may be based on an extra amount, and the extra amount may include a parking fee, an entrance fee, or a toll. In one or more embodiments, the method may further include receiving, over the data network, a payment amount from the passenger user device. The method may include charging, to a passenger user corresponding to the passenger user device, the payment amount. The method may include making a payment to a driver user based on the payment amount. The driver user may correspond to the driver user device.

Another aspect of the disclosure includes a system. The system may implement one or more steps of the above-given method. The system may include a driver user device, one or more passenger user devices, a data network, one or more computer servers, or a social networking platform. Various steps of the above-given method may be implemented by a ride sharing mobile application executing on the driver user device or the one more passenger user devices. Various steps of the above-given method may be implemented by the one or more computer servers as a back-end portion of the ride sharing mobile application. In some embodiments, a user device may assume the role of a driver user device at one point in time, and assume the role of a passenger user device at another point in time.

Various embodiments of the present disclosure include technical improvements that improve the functioning of a computer, and other technology or technical fields. The present disclosure enhances the experience of driver users and passenger users by allowing the users to indicate the status of their respective devices to a backend system associated with a rideshare service (driver status: looking for carpool passengers; passenger status: looking for a ride). The backend system receives data from the driver user devices and the passenger user devices and configures itself to receive rideshare data from driver user devices and send ride proposals to eligible passenger user devices so that driver users and passenger users can coordinate ridesharing instantaneously and with minimal coordination between them. Various embodiments provide technical advantages such as reducing the number of irrelevant ride proposals sent to driver user devices, which minimizes the workload on the backend system and reduces the bandwidth usage of both the backend system and the driver user devices. Other technical advantages include reducing the number of wasted ride proposals sent from driver user devices to the backend system.

Numerous other aspects, objects, advantages, and features of the present disclosure will be readily apparent to those of skill in the art upon a review of the following drawings and description of a preferred embodiment.

### BRIEF DESCRIPTION OF THE DRAWINGS

FIG. 1 is a schematic block diagram illustrating one embodiment of a system for an integrated social networking mobile application with ride sharing program.

FIG. 2A is a flowchart illustrating one embodiment of a method for an integrated social networking mobile application with ride sharing program.

FIG. 2B is a flowchart illustrating one embodiment of a method for an integrated social networking mobile application with ride sharing program.

FIG. 3 is a flow diagram illustrating one embodiment of a data flow for an integrated social networking mobile application with ride sharing program.

FIG. 4A is a front view illustrating one embodiment of a driver user device for an integrated social networking mobile application with ride sharing program showing driver input data.

FIG. 4B is a front view illustrating another embodiment of a driver user device for an integrated social networking mobile application with ride sharing program showing driver input data.

FIG. 5 is a front view illustrating one embodiment of a passenger user device for an integrated social networking mobile application with ride sharing program showing passenger input data.

FIG. 6 is a front view illustrating another embodiment of the driver user device for an integrated social networking mobile application with ride sharing program showing a driver route and a passenger route.

FIG. 7A is a front view illustrating another embodiment of the driver user device for an integrated social networking mobile application with ride sharing program showing first rideshare data for the driver with an estimated passenger usage amount.

FIG. 7B is a front view illustrating another embodiment of the driver user device for an integrated social networking mobile application with ride sharing program showing passenger information.

FIG. 8A is a front view illustrating another embodiment of the passenger user device for an integrated social networking mobile application with ride sharing program showing a ride proposal.

FIG. 8B is a front view illustrating another embodiment of the passenger user device for an integrated social networking mobile application with ride sharing program showing another embodiment of the ride proposal.

FIG. 8C is a front view illustrating another embodiment of the passenger user device for an integrated social networking mobile application with ride sharing program showing another embodiment of the ride proposal.

FIG. 9A is a front view illustrating another embodiment of the driver user device for an integrated social networking mobile application with ride sharing program showing multiple passenger start locations.

FIG. 9B is a front view illustrating another embodiment of the driver user device for an integrated social networking mobile application with ride sharing program showing multiple passenger start locations.

FIG. 10 is a front view illustrating one embodiment of a user device for an integrated social networking mobile application with ride sharing program showing a driver or passenger selection screen.

### DETAILED DESCRIPTION

While the making and using of various embodiments of the present invention are discussed in detail below, it should be appreciated that the present invention provides many applicable inventive concepts that are embodied in a wide variety of specific contexts. The specific embodiments discussed herein are merely illustrative of specific ways to make and use the invention and do not delimit the scope of the invention. Those of ordinary skill in the art will recognize numerous equivalents to the specific apparatus and methods described herein. Such equivalents are considered to be within the scope of this invention and are covered by the claims.

In the drawings, not all reference numbers are included in each drawing, for the sake of clarity. In addition, positional terms such as “upper,” “lower,” “side,” “top,” “bottom,” etc. refer to the apparatus when in the orientation shown in the drawing. A person of skill in the art will recognize that the apparatus can assume different orientations when in use.

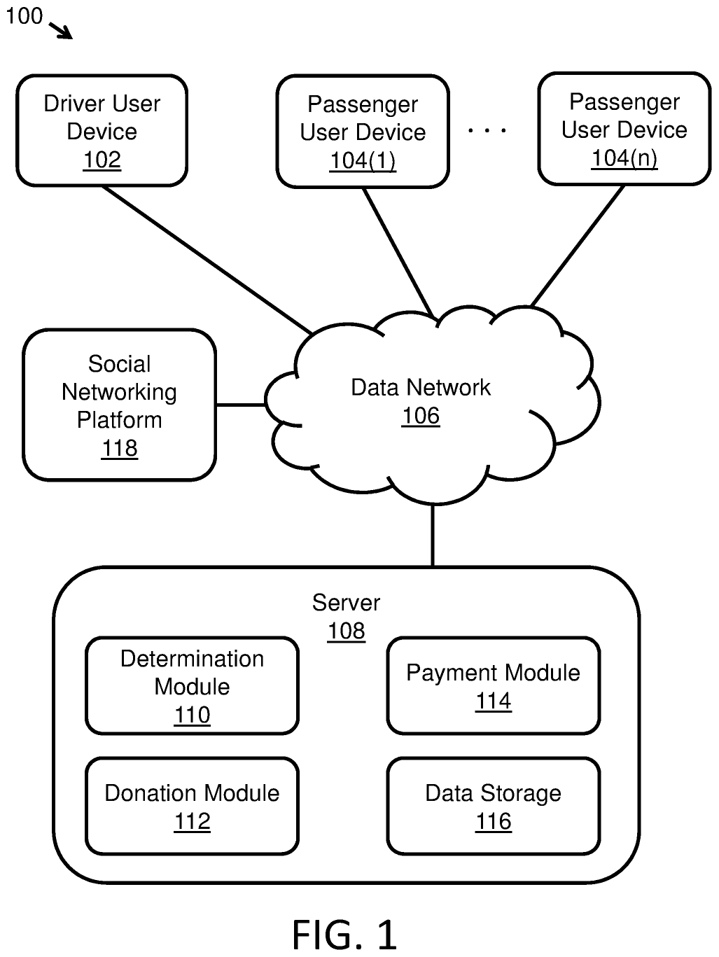

FIG. 1 depicts one embodiment of a system 100. The system 100 may include a system for an integrated social networking mobile application with ride sharing program, sometimes referred to simply as a “ride sharing mobile application.” The system 100 may include a driver user device 102. The system 100 may include one or more passenger user devices 104(1)-(n). The system 100 may include a data network 106. The system 100 may include a server 108. The driver user device 102, the passenger user devices 104(1)-(n), and the server 108 may be in data communication over the data network 106. The server 108 may include one or more modules. The one or more modules may include a determination module 110, a donation module 112, or a payment module 114. The server 108 may include a data storage 116. The system 100 may include a social networking platform 118. The social networking platform 118 may integrate with the driver user device 102, passenger user devices 104(1)-(n), or the server 108. The social networking platform 118 may send data to or receive data from the driver user device 102, passenger user devices 104(1)-(n), or the server 108 via the data network 106.

As a brief overview, one embodiment of the disclosure includes the ride sharing mobile application. The ride sharing mobile application may include a client-server framework where a front-end portion of the application may include a mobile application that executes on the driver user device 102 or the one or more passenger user devices 104(1)-(n), and a back-end portion may include software that executes on the server 108. The software may include the one or more modules 110-114.

A user of a mobile user device may use the mobile application to select whether the user is a driver or a passenger. As such, the system 100 may include two or more user devices with the capability to selectively alternate between being a driver user device 102 or a passenger user device 104. If a user selects the driver option on his or her mobile device, the user may be deemed a “driver user,” and the mobile device of the driver user may be deemed a driver user device 102. The driver user device 102 may present a map to the driver user via the user interface of the driver user device 102. The driver user may select a destination location using the map, and the driver user device 102 may send the destination location to the server 108. The driver user device 102 may also send a current location of the driver user device 102 to the server 108. If the user selects the passenger option, the user may be deemed a “passenger user,” and the mobile device of the passenger user may be deemed a passenger user device 104. The passenger user device 104 may similarly present a map to the passenger user, the passenger user may select a destination location using the map, and the passenger user device 104 may send the destination location (and possibly the current location of the passenger user device 104) to the server 108.

The server 108 may determine, from data received from the driver user device 102 and the passenger user devices 104(1)-(n), whether the received data satisfies some predetermined criteria such that it may be advantageous for the driver user and one or more passenger users to share a ride. Sharing the ride may include the driver user picking up the one or more passenger users and taking the driver user and the one or more passenger users to the same destination. If the server 108 determines that such criteria is satisfied by a driver user and one or more passenger users, the server 108 may send rideshare data to the driver user device 102 and ride proposal data to the one or more passenger user devices 104(1)-(n) notifying them of the rideshare opportunity. The server 108 may also (1) calculate an estimated passenger usage amount for each passenger user, (2) receive, from each passenger user, a payment amount that indicates how much the passenger user has selected to pay, charge the one or more payment amounts to their respective passenger users, and (3) pay the driver user based on the one or more payment amounts. The estimated passenger usage amount may include an estimated donation amount or a suggested donation amount. The server 108 may use the determination module 110, donation module 112, the payment module 114, or the data storage 116 to execute some of the above-mentioned functionality.

The following describes details of the one or more embodiments of the present disclosure. In one embodiment, the driver user device 102 may include a computing device. A computing device may include a personal computer, a laptop computer, a tablet computer, a smart phone, a smartwatch, a server (e.g., an application server, a database server, or another type of server), or some other type of computing device. In some embodiments, a computing device may include an network interface capable of facilitating network communication between the computing device and a network, such as the data network 106. In one embodiment, the computing device may include a global positioning system (GPS) receiver capable of determining the location of the computing device. In some embodiments, the computing device may include a user interface. The user interface may accept user input from a user of the computing device (e.g., via a touchscreen, a mouse, a keyboard, or other user input device). The user interface may produce output from the computing device to be perceived by the user (e.g., via a display screen, audio speakers, or other output device). In some embodiments, the one or more passenger user devices 104(1)-(n) may each include a computing device.

In one embodiment, the data network 106 may include one or more devices that facilitate the flow of data from one device to another. The data network 106 may include routers, switches, transmission servers, or other networking devices. Portions of the data network 106 may include wired or wireless data transmission. The data network 106 may include one or more local area networks (LANs), wide area networks (WANs), the Internet, or some other network.

In some embodiments, the server 108 may include a computing device. The server 108 may include one or more modules 110-114. A module may include software, hardware, or a combination of software and hardware. The one or more modules 110-114 may cause the server 108 to carry out functionality, such as one or more steps of the method 200, described below. In some embodiments, the server 108 may include at least one computer server or one or more computer servers. The one or more modules 110-114 may be distributed among the one or more computer servers. In some embodiments, the server 108 may include a virtual machine.

In one embodiment, the server 108 may include a data storage 116. The data storage 116 may include software or hardware that stores data. The data storage 116 may include a file system, cloud storage, a database, or another type of data storage. In some embodiments, another computing device that may be separate from the server 108 may include the data storage 116 and may be in data communication with the server 108, for example, over the data network 106. The data storage 116 may store data such as user account data, payment information, geolocation information, or other data.

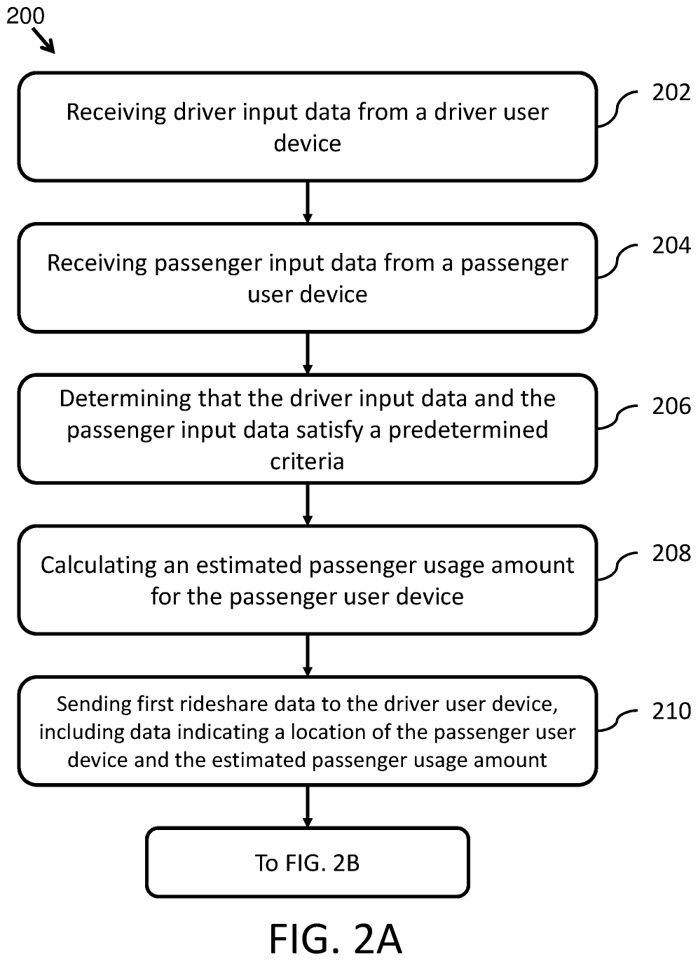

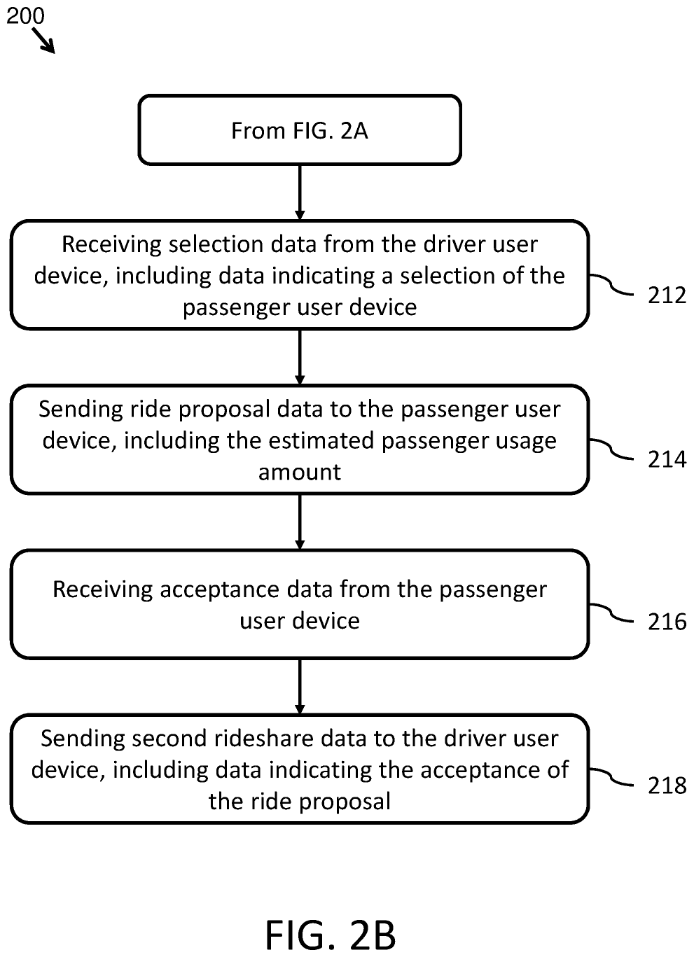

FIG. 2A and FIG. 2B depict one embodiment of a method 200. The method 200 may include a computer-implemented method. The method 200 may include a method for a computer-implemented ride-sharing mobile application. As a brief overview of the method 200, in one embodiment, the method 200 may include receiving 202, over a data network, driver input data from a driver user device. The driver input data may include data indicating a driver destination. The method 200 may include receiving 204, over the data network, passenger input data from a passenger user device. The passenger input data may include data indicating a passenger destination. The method 200 may include determining 206 that the driver input data and the passenger input data satisfy a predetermined criteria. The predetermined criteria may be based on, at least in part, the driver destination corresponding to the passenger destination. The driver destination corresponding to the passenger destination may include the driver destination matching the passenger destination. The driver destination corresponding to the passenger destination may include the driver destination being within a certain distance threshold of the passenger destination. The method 200 may include calculating 208 an estimated passenger usage amount for the passenger user device. The method 200 may include sending 210, over the data network, first rideshare data to the driver user device. The first rideshare data may include data indicating a location of the passenger user device and the estimated passenger usage amount. In some embodiments, step 210 may occur in response to determining that the driver input data and passenger input data satisfy the predetermined criteria at step 206.

The method 200 may include receiving 212, over the data network, selection data from the driver user device. The selection data may include data indicating a selection of the passenger user device. The method 200 may include sending 214, over the data network, ride proposal data to the passenger user device. The ride proposal data may include the estimated passenger usage amount. The method 200 may include receiving 216, over the data network, acceptance data from the passenger user device. The acceptance data may include data indicating an acceptance, from the passenger user device, corresponding to the ride proposal data. The method 200 may include sending 218, over the data network, second rideshare data to the driver user device. The second rideshare data may include data indicating of the acceptance from the passenger user device.

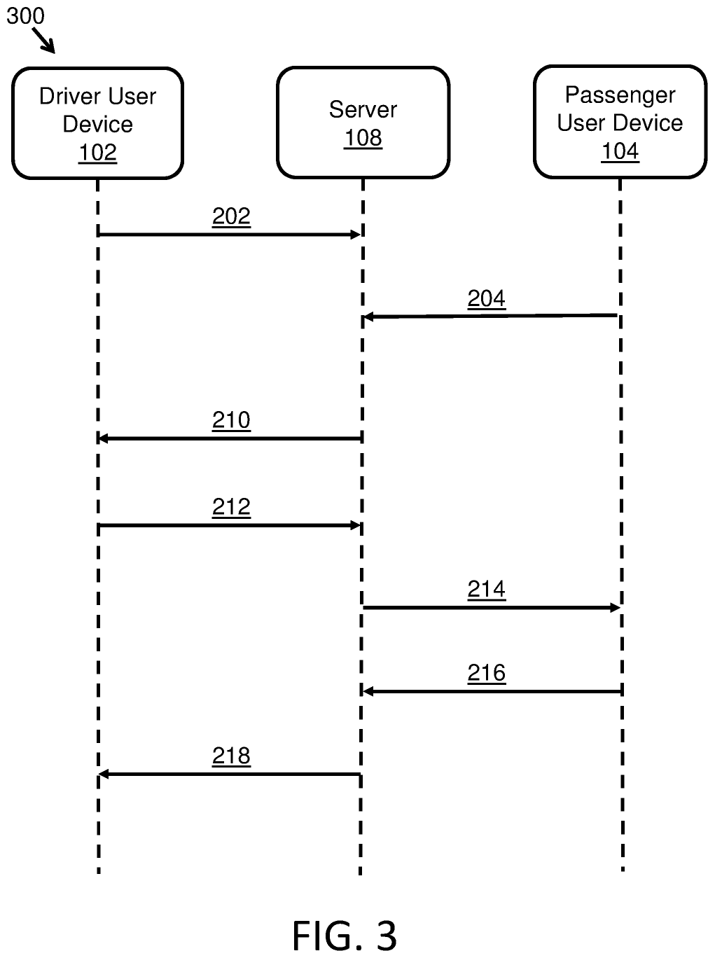

FIG. 3 depicts one embodiment of a flow 300 of data between the driver user device 102, the passenger user device 104, and the server 108 during performance of one embodiment of the method 200. The driver user device 102 may send the driver input data to the server 108 during the step 202. The passenger user device 104 may send the passenger input data to the server 108 during the step 204. Although FIG. 3 shows step 202 occurring before step 204, in some embodiments, steps 202 may occur after step 204, or step 202 and step 204 may occur simultaneously.

The server 108 may send the first rideshare data to the driver user device 102 during the step 210. The driver user device 102 may send the selection data to the server 108 during the step 212. The server 108 may send the ride proposal data to the passenger user device 104 during the step 214. The passenger user device 104 may send the acceptance data to the server 108 during the step 216. The server 108 may send the second rideshare data to the driver user device 102 during the step 218.

The following describes details of one or more embodiments of the method 200 of the present disclosure. In some embodiments, the driver input data of the receiving 202 step may include data indicating a driver destination. The driver destination may include a location that the driver user of the driver user device 102 wishes to travel to. The driver input data may include a driver start location. The driver start location may include the current location of the driver user device 102 or a future, planned location of the driver user device 102. The driver input data may include a future time, such as a time in the future that the driver user of the driver user device 102 wishes to (1) leave the driver start location, or (2) arrive at the driver destination. The future time may include the time at which some other event regarding the driver user occurs. In some embodiments, the driver input data may include data indicating a selection, by the driver user of the driver user device 102, on the driver user device 102 that the user of the driver user device 102 is acting as a driver.

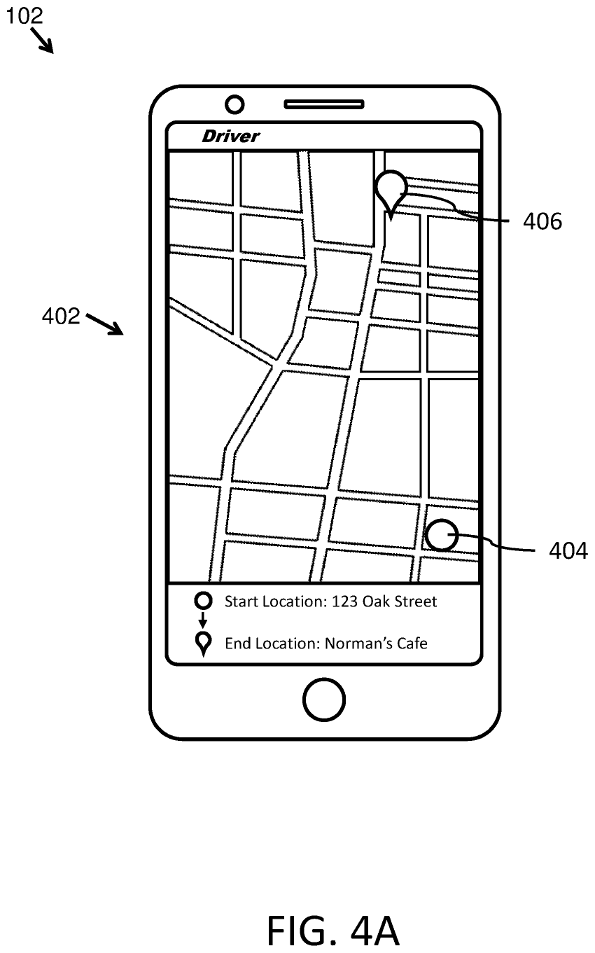

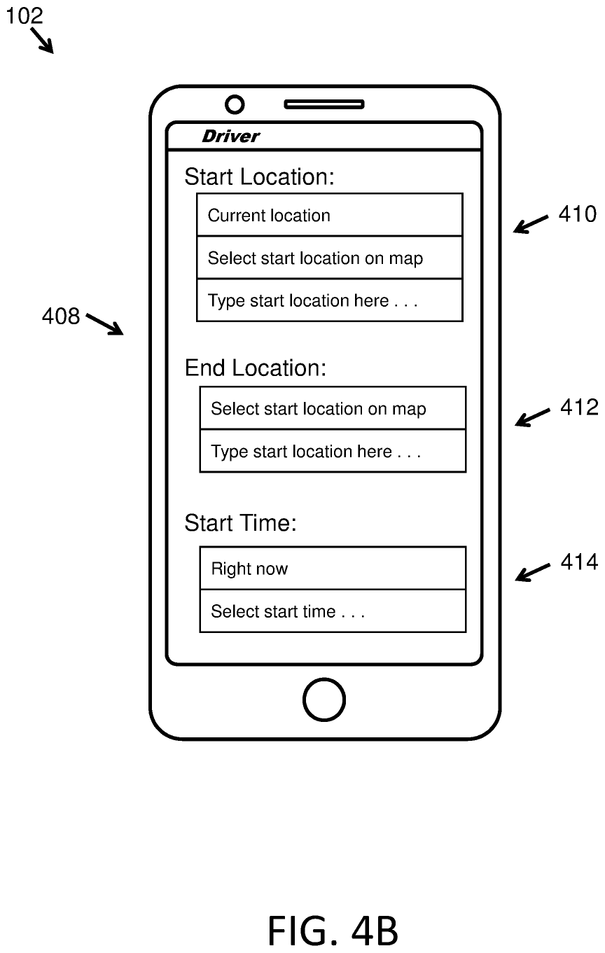

FIG. 4A depicts one embodiment of a driver user device 102. The driver user device 102 may include a software application installed on the driver user device 102. The software application may include a front-end portion of a ride sharing mobile application. The driver user device 102 may include a map 402. The ride sharing mobile application of the driver user device 102 may include the map 402 and may display the map 402. The driver user device 102 may display the map 402 on a user interface (e.g., as shown in FIG. 4A, a touchscreen) of the driver user device 102. The map 402 may include a visual representation of map data received by the ride sharing mobile application of the driver user device 102 from the server 108 over the data network 106. The map 402 may include a driver start location 404. The driver start location 404 may include a current location of the driver user device 102. The driver start location 404 may include a future location of the driver user device 102. The map 402 may include a driver destination 406. In some embodiments, the driver user of the driver user device 102 may select the driver start location 404 or the driver destination 406 on the driver user device 102. For example, the driver user may interact with a touchscreen of the driver user device 102 to search for and/or select the driver start location 404 or the driver destination 406.

In some embodiments, the map 402 may include a web mapping provided by a third-party service. The map 402 may include a map provided by GOOGLE Maps, APPLE Maps, BING Maps, or some other service. Data representations on the map 402, such as the driver start location 404 or the driver destination 406 may include an overlay on the map 402 received from the third-party service.

FIG. 4B depicts one embodiment of the driver user device 102. The rideshare mobile application of the driver user device 102 may include a trip planning screen 408. In one embodiment, the trip planning screen may include a start location option 410. The start location option 410 may allow the driver user of the driver user device 102 to choose the driver start location 404. In one embodiment, the start location option 410 may include a drop-down menu with one or more options for choosing the driver start location 404. For example, as depicted in FIG. 4B, the start location option 410 drop-down menu may include an option for choosing the driver user device's 102 current location (as determined by the GPS receiver of the driver user device 102 or other hardware of the driver user device 102). The start location option 410 drop-down menu may include an option for selecting the driver start location 404 on the map 402. In response to the driver user selecting this option, the trip planning screen 408 may transition to the map 402 of FIG. 4A. The start location option 410 drop-down menu may include an option for typing in the driver start location 404 (e.g., as an address).

In some embodiments, the trip planning screen 408 may include an end location option 412. The end location option 412 may allow the driver user to choose the driver destination 406. The end location option 412 may include similar functionality to the start location option 410. The trip planning screen 408 may include a start time option 414. The start time option 414 may allow the driver user to choose the time at which the driver user will start his or her ride. The start time option 414 may include a drop-down menu with one or more options that the driver user may select from. For example, as shown in FIG. 4B, the start time option 414 drop-down menu may include an option for choosing the current time (i.e., “right now”) as the start time. The start time option 414 drop-down menu may include an option for choosing a time in the future. In response to the driver user selecting this option, the driver user device 102 may present a screen where the driver user can select a future time or date.

In some embodiments, the trip planning screen 408 may include a different option types other than drop-down menus. In one embodiment, the trip planning screen 408 may include an end time option where the driver user may choose a time the driver user wishes to arrive at the driver destination 406 instead of choosing a time the driver user wishes to leave the driver start location 404.

In one embodiment, the passenger input data of the receiving 204 step may include data indicating the passenger destination. The passenger input data may include data indicating a passenger start location. The passenger start location may include a current passenger location or a future passenger location. The passenger input data may include data indicating a future time, such as a future time at which the passenger user wishes to be picked up or a future time at which the passenger user wishes to arrive at the passenger destination. The passenger input data may include a selection on the passenger user device that the user of the passenger user device is acting as a passenger user.

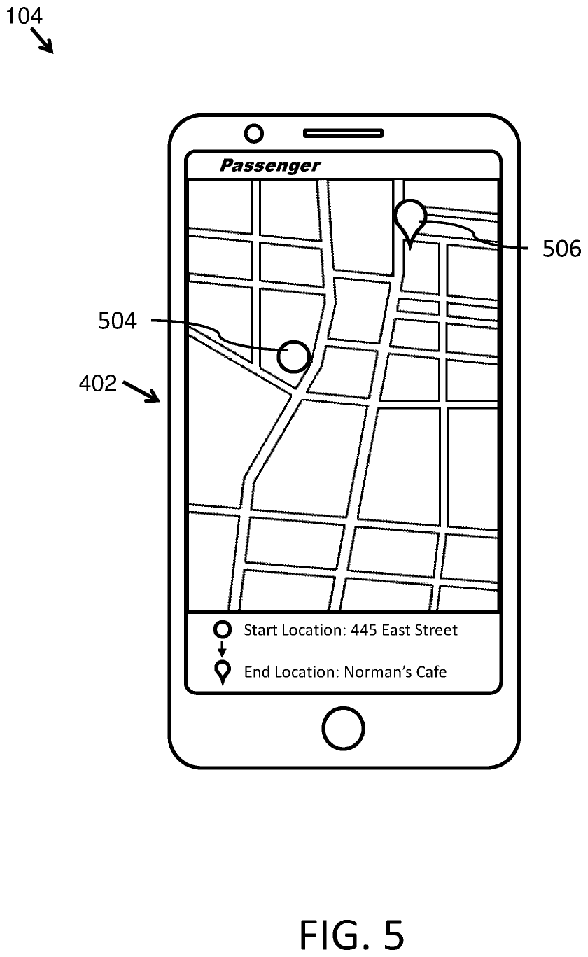

FIG. 5 depicts one embodiment of a passenger user device 104. The passenger user device 104 may be similar to the driver user device 102. The passenger user device 104 may include the map 402. The map 402 may include a passenger start location 504. The map 402 may include a passenger destination 506. The passenger start location 504 or the passenger destination 506 may be similar to the driver start location 404 or the driver destination 406, respectively. A passenger user may interact with the passenger user device 104 in a similar manner to the manner the driver user may interact with the driver user device 102.

In some embodiments, the passenger user device 104 may include a trip planning screen similar to the trip planning screen 408 of the driver user device 102 as depicted in FIG. 4B. The trip planning screen of the passenger user device 104 may include one or more menu options (such as the options 410, 412, or 414 of the FIG. 4B) that may allow the passenger user to choose the passenger start location 504, the passenger destination 506, or a time that the passenger user wishes to be picked up or a time the passenger user wishes to arrive at the passenger destination 506 (which may include the current time or a future time).

In one embodiment, a data representation of a location (e.g., the driver destination 406, passenger destination 506, driver start location 404, passenger start location 504, etc.) may include an address, GPS coordinates, or other ways to represent a location. A time (e.g., the future time mentioned above) may include a clock time (e.g., 13:45:01) or a calendar date (e.g., May 14, 2021). In some embodiments, a time may include a time range (e.g., 2:00 p.m. to 2:15 p.m.).

In one embodiment, the predetermined criteria of the determining step 206 may include the driver destination 406 corresponding to the passenger destination 506, which may include the driver destination 406 matching the passenger destination 506 or the driver destination 406 being within a threshold distance of the passenger destination 506. In some embodiments, the predetermined criteria of the determining 206 step may include a passenger route being within a variance threshold of a driver route. In one embodiment, the passenger route may include a route from the driver start location 404 to a location of the passenger user device 104 (e.g., the passenger start location 504) to the driver destination 406. In some embodiments, the passenger route may include a route from the driver start location 404 to the location of the passenger user device 104 (e.g., the passenger start location 504) to the passenger destination 506 (which may be different than the driver destination 406). In other embodiments, the passenger route may include a route from the passenger start location 504 to the passenger destination 506.

The driver route may include a route from the driver start location to the driver destination. In one embodiment, the determination module 110 may perform the determining step 206.

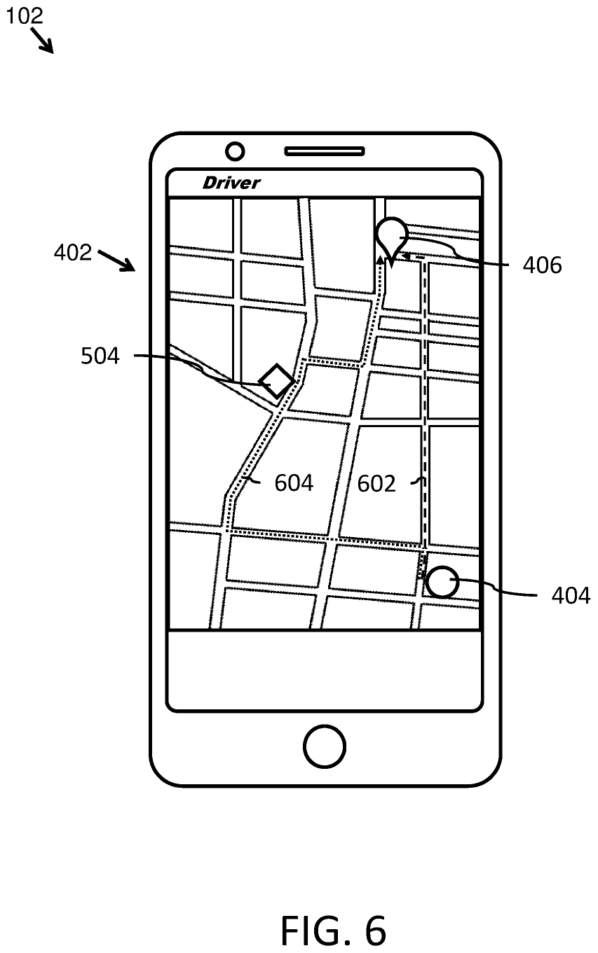

FIG. 6 depicts one embodiment of the driver user device 102. The map 402 may include a driver route 602. The driver route 602 may include a route from the driver start location 404 to the driver destination 406. The map 402 may include a passenger route 604. As shown in FIG. 6, the passenger route 604 may include a route from the driver start location 404 to the passenger start location 504 and a route from the passenger start location 504 to the driver destination 406. In some embodiments, the passenger route 604 may include a route from the driver start location 404 to a location of the passenger user device 104 (e.g., the passenger start location 504) to the driver destination 406. In some embodiments, the passenger route 604 may include a route from the driver start location 404 to the location of the passenger user device 104 (e.g., the passenger start location 504) to the passenger destination 506 (which may be different than the driver destination 406). In other embodiments, the passenger route 604 may include a route from the passenger start location 504 to the passenger destination 506.

In one embodiment, the server 108 may generate the driver route 602 or the passenger route 604. In some embodiments, the server 108 may send data (such as the driver start location 404, passenger start location 504, or driver destination 406) to a third-party web mapping service, and the third-party service may generate the driver route 602 or the passenger route 604 and sent the routes 602, 604 to the server 108. The server 108 may send the routes 602, 604 to the driver user device 102. In one embodiment, the routes 602, 604 may be generated based on minimizing distance travelled, minimizing time spent travelling, avoiding traffic, avoiding tolls, avoiding highways, avoiding bridges, or avoiding other travel phenomena.

In one embodiment, the variance threshold may include a distance variance threshold. In response to the distance of the passenger route 604 being within a threshold variance of the distance of the driver route 602, the driver input data and the passenger input data may satisfy the predetermined criteria. As an example, the distance threshold may include 2 miles (approx. 3.2 kilometers). The distance of the passenger route 604 may include 3.2 miles (approx. 5.15 km), and the distance of the driver route 602 may include 2.1 miles (approx. 3.38 km). Since the passenger route 604 is 1.1 miles (approx. 1.77 km) longer than the driver route 602, the passenger route 604 is within the distance variance threshold and the predetermined criteria is satisfied. As a second example, the distance threshold may again include 2 miles (approx. 3.2 kilometers). The distance of the passenger route 604 may include 5.6 miles (approx. 9.01 km), and the distance of the driver route 602 may again include 2.1 miles (approx. 3.38 km). Since the passenger route 604 is 3.5 miles (approx. 5.63 km) longer than the driver route 602, the passenger route 604 is not within the distance variance threshold and the predetermined criteria is not satisfied. In other embodiments, the distance threshold may be set by the driver user and may vary between about 1 to 50 miles (approx. 1.61 km to 80.47 km).

In some embodiments, the variance threshold may include a time variance threshold. In response to the travel time of the passenger route 604 being within a threshold of the travel time of the driver route 602, the driver input data and the passenger input data may satisfy the predetermined criteria. As an example, the time threshold may include 10 minutes. The travel time of the passenger route 604 may include 25 minutes, and the travel time of the driver route 602 may include 19 minutes. Since the travel time of the passenger route 604 is 6 minutes longer than the travel time of the driver route 602, the passenger route 604 is within the time variance threshold and the predetermined criteria is satisfied. As another example, the time threshold may again include 10 minutes. The travel time of the passenger route 604 may include 35 minutes, and the travel time of the driver route 602 may again include 19 minutes. Since the travel time of the passenger route 604 is 16 minutes longer than the travel time of the driver route 602, the passenger route 604 is not within the time variance threshold and the predetermined criteria is not satisfied. In other embodiments, the time threshold may be set by the driver user and may vary from about one minute to one hour.

In some embodiments, the variance threshold may include a distance between the driver user device 102 and the passenger user device 104. In response to the passenger user device 104 being located within a threshold distance of the location of the driver user device 102, the predetermined criteria may be satisfied. For example, the threshold distance may include 5 miles (8.05 km). The driver user device 102 may be located 3 miles away from the passenger user device 104. Thus, the passenger user device 104 is within the distance threshold, and the predetermined criteria is satisfied. In other embodiments, the threshold distance may be set by the driver user and may vary between about 1 to 20 miles.

In one embodiment, other predetermined criteria may be used. In some embodiments, multiple predetermined criteria may be used. In one embodiment, the driver user device 102 may select a threshold. In another embodiment, the passenger user device 104 may select a threshold.

In some embodiments, calculating 208 the estimated passenger usage amount for the passenger user device may be based on, at least in part, one or more factors. The one or more factors may include the passenger user's portion of the driver user's cost for carrying out the ride. For example, the cost of the driver user driving the driver route 602 (i.e., not carpooling with any passenger users) may be $2.00 (based on the distance of the driver route 602, the driver user's vehicle's fuel efficiency, wear-and-tear on the driver user's vehicle, etc.). In one embodiment, the driver user's cost for carrying out the ride may be split evenly by the passenger users participating in the ride. For example, continuing the previous example, if there are two passenger users, each of their portion of the driver's user's cost for carrying out the ride may be $1.00. In another embodiment, the driver user's cost for carrying out the ride may be split by the passenger users participating in the ride based on a fuel efficiency of the passenger user's vehicle. For example, continuing the previous example, if there are two passenger users and the first passenger user's vehicle is more fuel efficient than the second passenger user's vehicle, the first passenger user's portion may be $0.80 and the second passenger user's portion may be $1.20. In some embodiments, the one or more passenger users participating in the ride may not pay any of the driver user's cost.

In some embodiments, the one or more factors may include an added distance corresponding to the passenger user device 104. The added distance corresponding to the passenger user device 104 may include the distance added on to the driver route 602 in response to the driver user giving a ride to the passenger user. The distance added on to the driver route 602 in response to the passenger user may include the passenger user's portion of the passenger route 604. For example, the driver route 602 may include 2.1 miles (approx. 3.38 km). The added distance corresponding to a first passenger user device 104(1) may include 1.1 miles (approx. 1.77 km), and the added distance corresponding to a second passenger user device may include 0.5 miles (approx. 0.8 km), making the passenger user route 604 include a total distance of 3.7 miles (approx. 5.95 km). The estimated passenger usage amount for the first passenger user may be based, at least in part, on the 1.1 miles, and the estimated usage amount for the second passenger user may be based, at least in part, on the 0.5 miles. The cost of the added distance corresponding to each passenger user may be based, at least in part, on a fuel efficiency of the passenger user's vehicle. For example, two passenger users may add the same added distance amount to the ride, but the first passenger user's vehicle may be more fuel efficient than the second's. In this case, the first passenger user's added distance cost may be lower than the second user's added distance cost. In some embodiments, the added distance amount may be added to the passenger's portion of the driver's cost in determining the estimated passenger usage amount.

In some embodiments, the estimated passenger usage amount corresponding to the added distance may be based on a cost-distance calculation. The cost-distance calculation may calculate a cost-per-distance unit of the added distance. The amount of the cost-per-distance unit may be based on one or more cost factors. The one or more cost factors may include fuel prices, a fuel efficiency of the driver vehicle or a vehicle of a passenger user, wear-and-tear on the driver vehicle, the location of the trip (e.g., travel in the city may cost more than travel on a freeway), or other cost factors.

In one embodiment, the one or more factors may include a distance corresponding to a passenger-destination difference. The distance corresponding to the passenger-destination difference may include the distance from the passenger start location 504 to the driver destination 406. For example, the distance on the passenger route from the passenger start location 504 to the driver destination 406 may include 15.4 miles (approx. 24.78 km). The estimated passenger usage amount may be based, at least in part, on the 15.4 miles.

In one embodiment, the one or more factors may include a fuel-efficiency of a vehicle of the passenger user. If a passenger user uses a less-fuel efficient vehicle, then the passenger user may incur a larger estimated passenger usage amount. This may be because, since the user is saving more money on fuel, that passenger user should bear more of the cost of the ride. For example, the vehicle of the passenger user may include a fuel efficiency of 10 miles per gallon (MPG) (approx. 4.25 km per liter (KPL)). If the fuel efficiency of the passenger were instead 20 MPG (approx. 8.5 KPL), then the estimated passenger usage amount may be less. In some embodiments, the server 108 may store the fuel efficiency of a vehicle of the passenger user.

In some embodiments, the users may divide the cost of the trip, and the portion of the trip each user is responsible for may correspond to that respective user's vehicle's fuel efficiency. For example, three users (two passenger users and one driver user) may share a ride with a total distance of 41.3 miles (approx. 66.47 km). The first user's vehicle's fuel efficiency may be 10 MPG, the second user's vehicle's fuel efficiency may be 20 MPG, and the third user's vehicle's fuel efficiency may be 27 MPG. Dividing the total cost of the trip based on the fuel efficiencies, the first user would be responsible for 22.09 miles (approx. 35.55 km), the second user would be responsible for 11.04 miles (approx. 17.77 km), and the third user would be responsible for 8.17 miles (approx. 13.15 km).

In one embodiment, the one or more factors may include a cost-distance analysis of a route to the driver destination. The cost-distance analysis may be similar to the cost-distance calculation described above. The cost-distance analysis may apply to the entire trip and not just to the added distance corresponding to the passenger.

In some embodiments, the estimated passenger usage amount may be based, at least in part, on an extra charge. The extra charge may include a parking fee, an entrance fee, a toll, or another type of extra charge. The driver user and the one or more passenger users may divide up the extra charge evenly or may divide up the extra charge based on some other manner of dividing costs. In some embodiments, the donation module 112 may perform the calculating 208 step.

In some embodiments, the one or more factors may include a division of the total distance of the trip. In one embodiment, a division of the total distance may include the one or more passenger users and the driver user splitting the cost of the trip. As an example, the total trip distance may include 35.7 miles (approx. 57.45 km). Three passenger users and a driver user may participate in the trip. The users may split the cost of the 35.7 mile trip. In one embodiment, the users may split the trip evenly (i.e., each user is responsible for one-fourth of the trip (approx. 8.9 miles or 14.32 km)). In another embodiment, a division of the of the total distance may include only the one or more passenger users splitting the cost of the trip. As another example, the total trip distance may include 35.6 miles, three passenger users and a driver user may participate in the trip, and only the three passenger users may split the cost of the 35.7 miles. In another embodiment, the users may split the trip according to other factors. In some embodiments, only the one or more passenger users may split the cost of the trip, and in other embodiments, the driver may be included in splitting the cost of the trip.

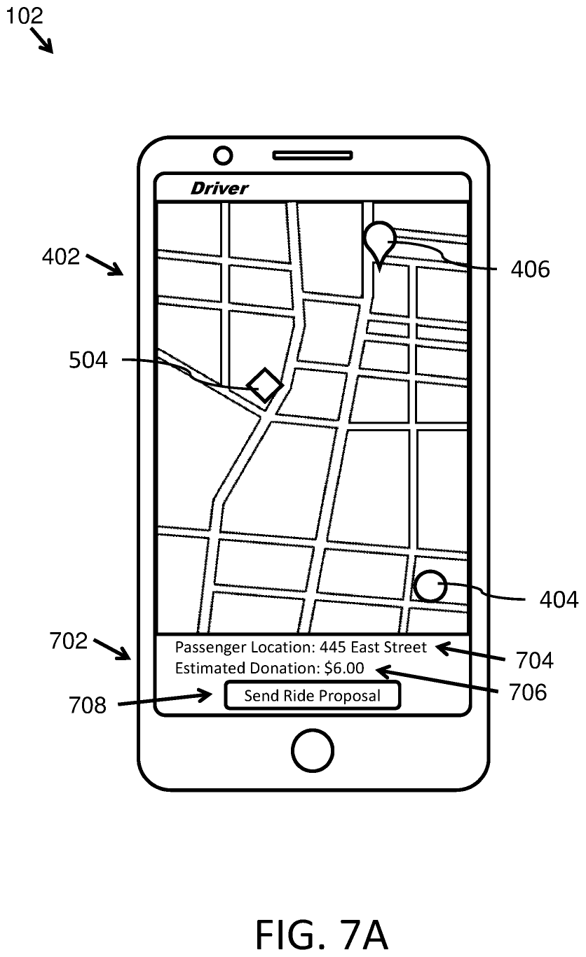

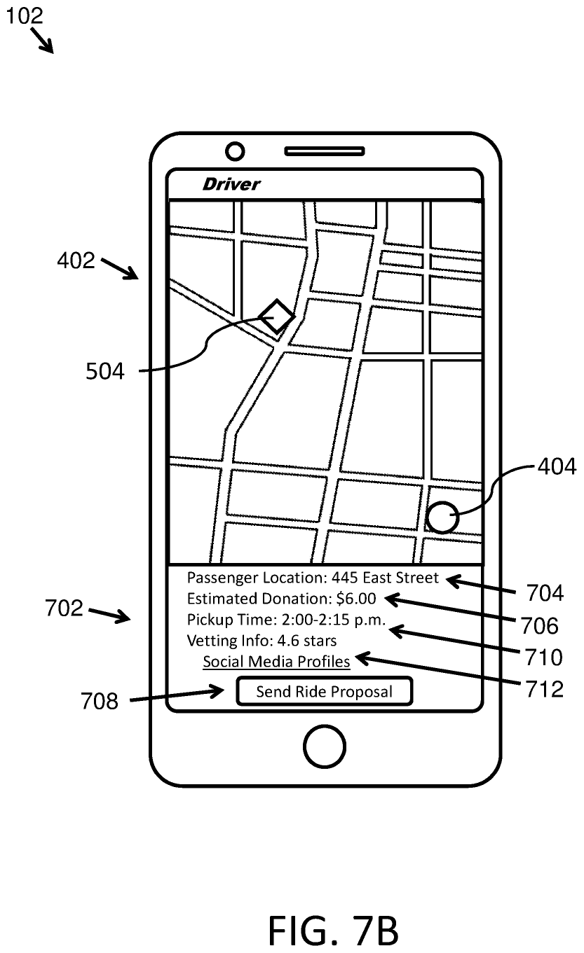

FIG. 7A depicts one embodiment of a driver user device 102. In one embodiment, in response to determining 206 that the driver input data and passenger input data satisfy the predetermined criteria, the server 108 may send 210, over the data network 106, the first rideshare data to the driver user device 102. The first rideshare data may include data indicating the location of the passenger user device 104. The first rideshare data may include data indicating the estimated passenger usage amount.

In one embodiment, the driver user device 102 may display at least a portion of the first rideshare data. For example, the map 402 of the driver user device 102 may display the data indicating the location of the passenger user device 104 as the passenger start location 504. The passenger start location 504 may correspond to a passenger user whose passenger input data satisfied the predetermined criteria of the step 206. In response to the driver user of the driver user device 102 selecting the passenger start location 504 (e.g., by tapping on the passenger start location 504 on the touchscreen of the driver user device 102), the driver user device 102 may display passenger information 702. The passenger information 702 may include at least a portion of the first rideshare data.

In some embodiments, the passenger information 702 may include location data 704 indicating a location of the passenger user device. The location data 704 may include an address corresponding to the passenger user of the passenger user device, such as the passenger user's current location or a future location of the passenger user. The passenger user information 702 may include the estimated passenger usage amount 706. In one embodiment, the passenger information 702 may include a button 708. The button 708 may include functionality such that when the driver user of the driver user device 102 presses the button 708, the driver user device 102 may send selection data to the server 108. The selection data may include data indicating the selection of the passenger user device 104 corresponding to the passenger start location 504.

FIG. 7B depicts another embodiment of the driver user device 102. In some embodiments, the passenger information 702 may further include a passenger pick up time 710. The passenger pick up time 710 may include the current time (i.e., immediate pick up), a future time, a time range, or other time data. In some embodiments, the passenger information 702 may further include passenger vetting data 712. The passenger vetting data 712 may include vetting data corresponding to a passenger user of the passenger user device 104. The passenger vetting data 712 may include information about the passenger user of the passenger user device 104 that the driver user of the driver user device 102 may use to determine whether the driver user wishes to send a ride proposal to the passenger user device 104.

In one embodiment, the passenger vetting data 712 may include a link to one or more social media profiles of the passenger user on one or more social networking platforms (such as the social networking platform 118). The passenger vetting data 712 may include a link to a third-party website with vetting information about the passenger user. The passenger vetting data 712 may include a rating or feedback about the passenger user (which may be stored on the server 108, on the social networking platform 118, or by some other service or third party). For example, as depicted in FIG. 7B, the passenger vetting data 712 may include a rating (i.e., “4.6 stars”) compiled from feedback by other driver users, where 1 star is a low rating and 5 stars is a high rating. The driver user may interact with the rating (e.g., by tapping on the passenger vetting data 712) and the driver user device 102 may display one or more ratings left by individual driver users for the passenger, which may include the star rating provided by the individual driver user, text comments, or other vetting data. In one embodiment, the passenger information 702 may further include other data.

In one embodiment, the server 108 may receive 212 the selection data from the driver user device 102 over the data network 106. The driver user device 102 may have sent the selection data in response to the driver user selecting the data representing the passenger user device 104 (e.g., the passenger start location 504 on the map 402) and pressing the button 708. The server 108, in response to receiving 212 the selection data may send 214 ride proposal data to the passenger user device 104 over the data network 106. The passenger user device 104 may include the passenger user device corresponding to the selection data selected by the driver user device 102.

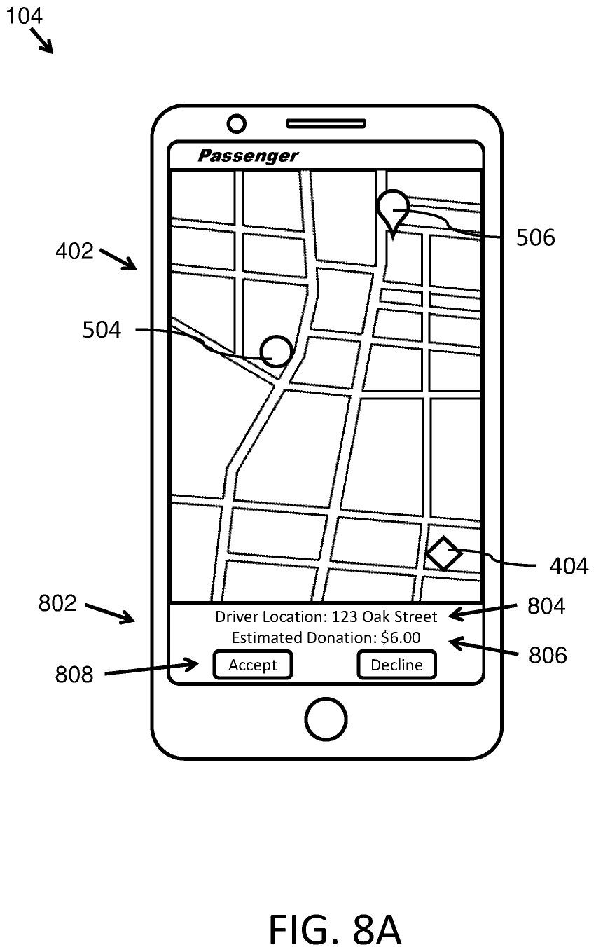

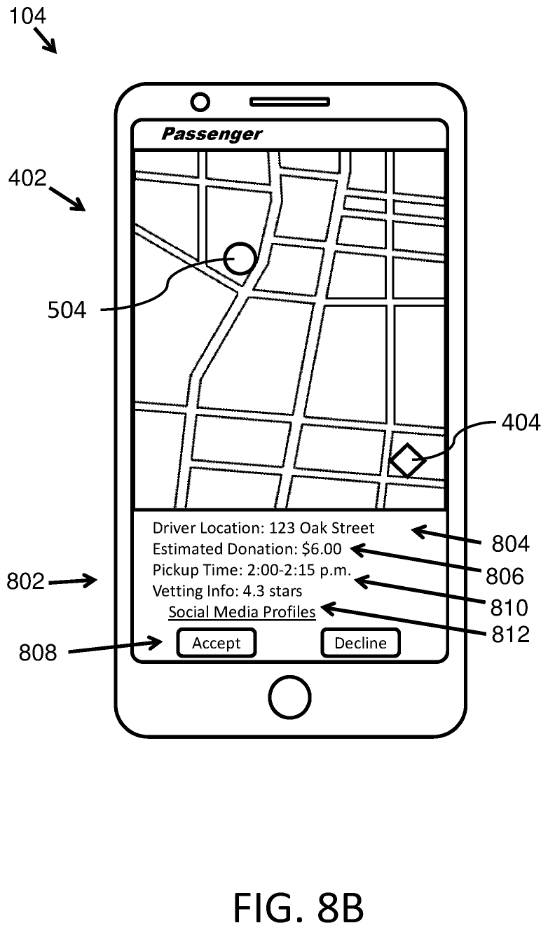

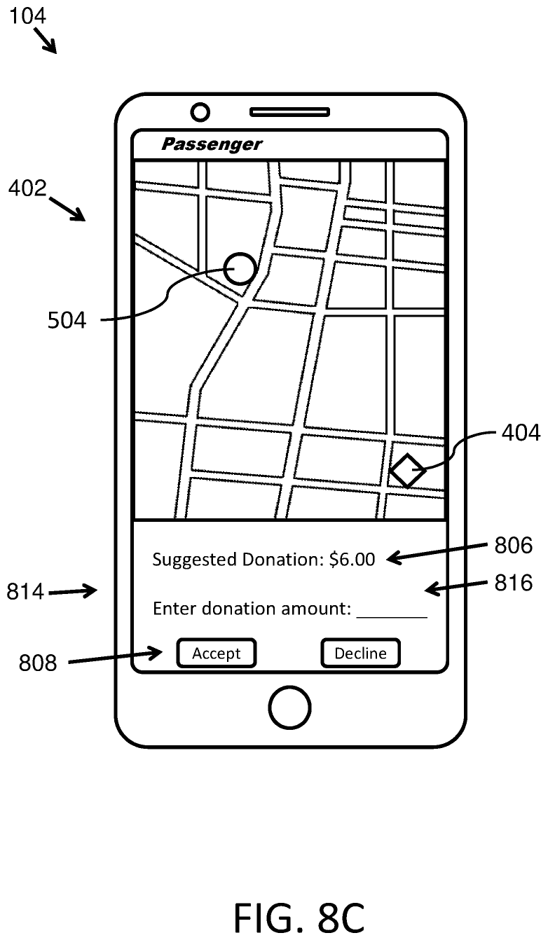

FIG. 8A depicts one embodiment of a passenger user device 104. The passenger user device 104 may receive the ride proposal data from the server 108. The passenger user device 104 may display at least a portion of the ride proposal data as a ride proposal 802. In one embodiment, the ride proposal data may include the driver start location 404, and the map 402 may display the driver start location 404. In one embodiment, the ride proposal 802 may include location data 804 indicating the driver start location in the form of an address. The ride proposal may include the estimated passenger usage amount 806.

In some embodiments, the ride proposal 802 may include one or more buttons 808. The one or more buttons may include functionality to accept or decline a ride corresponding to the ride proposal data. In one embodiment, in response to the passenger user using the one or more buttons 808 to accept the ride corresponding to the ride proposal data, the passenger user device 104 may send acceptance data of the ride proposal 802 to the server 108. In some embodiments, in response to the passenger user using the one or more buttons 808 to decline the ride corresponding to the ride proposal 802, the passenger user device 104 may send decline data of the ride proposal data to the server 108.

FIG. 8B depicts another embodiment of the passenger user device 104. In some embodiments, the ride proposal 802 may further include a time 810. The time 810 may correspond to a time when the ride corresponding to the ride proposal 802 is scheduled to occur. For example, the time 810 may include a time the driver user is scheduled to being the ride, a time the passenger user is scheduled to be picked up by the driver user, or another time. The ride proposal 802 may include driver vetting data 812. The driver vetting data 812 may include vetting data corresponding to the driver user of the driver user device 102. The driver vetting data 812 may include a link to one or more social media profiles of the driver user on one or more social networking platforms (such as the social networking platform 118). A social networking platform linked to by the driver vetting data 812 may be different than a social networking platform linked to by the passenger vetting data 712. The driver vetting data 812 may include a rating or feedback about the driver user that corresponds to the ride proposal 802, similar to the passenger vetting data 712 described above.

In one embodiment, in response to a passenger user device 104 using the one or more buttons 808 to decline the ride corresponding to the ride proposal data, the passenger user device 104 may display a prompt 814 on the passenger user device 104. As depicted in FIG. 8C, the prompt 814 may include text indicating the estimated passenger usage amount 806. The estimated passenger usage amount 806 may include a suggested donation amount. The prompt 814 may include an area 816 for the passenger user of the passenger user device 104 enter an adjusted passenger usage amount.

In some embodiments, the adjusted passenger usage amount may be different from the estimated passenger usage amount 806. The adjusted passenger usage amount may be higher or lower than the estimated passenger usage amount 806. In one embodiment, the adjusted passenger usage amount may include the amount of the estimated passenger usage amount 806 plus an upcharge amount (e.g., an amount additional to the estimated passenger usage amount 806, such as a tip). For example, if the estimated passenger usage amount 806 for the passenger user were $6.00, and the passenger user entered an adjusted passenger usage amount of $8.00, then the upcharge amount may be $2.00. In one or more embodiments, the passenger user device 104 may not allow the passenger user to input less than the estimated passenger usage amount 806 in the area 816 as the adjusted passenger usage amount.

In some embodiments, the area 816 may include a textbox where the passenger user can type the adjusted passenger usage amount, a scroll wheel that includes various amounts, or some other graphical menu including options for selecting the adjusted passenger usage amount. The passenger user may select the “accept” button from the buttons 808 to finalize the adjusted passenger usage amount. The passenger user may select the “decline” button from the buttons 808 to decline the ride completely.

In response to the passenger user entering the adjusted passenger usage amount into the prompt 814 and selecting the “accept” button from the buttons 808, the passenger user device 104 may modify the ride proposal 802 to include the adjusted passenger usage amount as the estimated passenger usage amount 806 and send the acceptance data to the server 108. The server 108 may receive the acceptance data (e.g., as part of step 216) and, in some embodiments, the donation module 112 or other component of the server 108 may determine whether the adjusted passenger usage amount is within a range of fair passenger usage amounts, or perform some other functionality.

The server 108 may receive 216, over the data network, the acceptance data from the passenger user device 104. The acceptance data may include an acceptance, from passenger user device 104, corresponding to the ride proposal 802. The acceptance data may include the estimated passenger usage amount 806 (i.e., the original passenger usage amount that was accepted by the passenger user) or the adjusted passenger usage amount, as described above. The server 108 may send 218, over the data network, second rideshare data to the driver user device 102. The second rideshare data may include at least a portion of the acceptance data received from the passenger user device 104. For example, the second rideshare data may include data indicating that the passenger user has accepted the ride or the adjusted passenger usage amount. The second rideshare data may include the estimated passenger usage amount 806 or the adjusted passenger usage amount.

In one embodiment, in response to receiving the second rideshare data and in response to the second rideshare data including the adjusted passenger usage amount (instead of the estimated passenger usage amount 706), the driver user device 102 may display the adjusted passenger usage amount to the driver user and may provide an option for the driver user to accept or decline the adjusted passenger usage amount. In response to the driver user selecting to decline the adjusted passenger usage amount (e.g., because the driver user believes the adjusted passenger usage amount to be unfair), the driver user device 102 may send data to the server 108 indicating the decline, and the server 108 may send data to the passenger user device 104 indicating the decline.

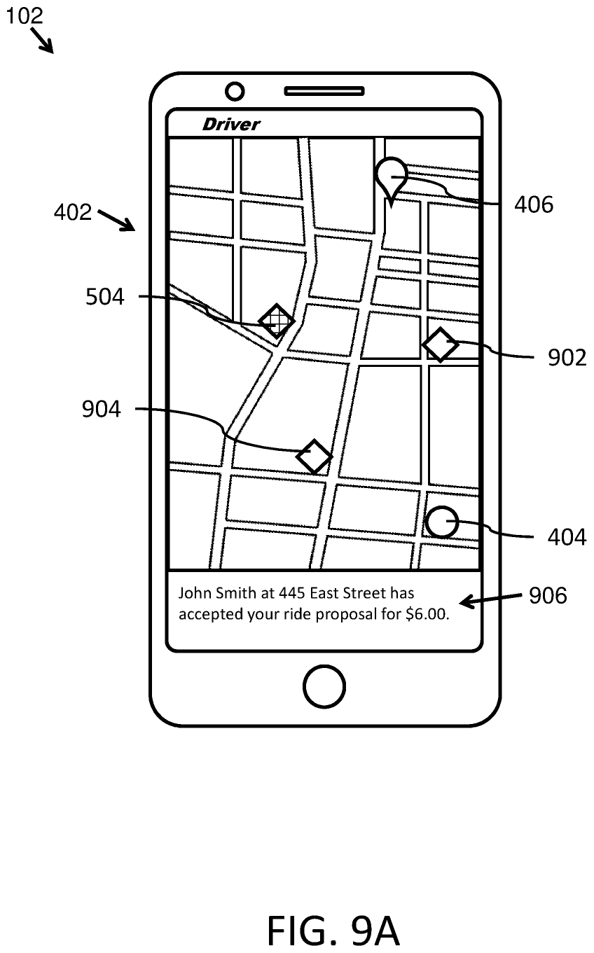

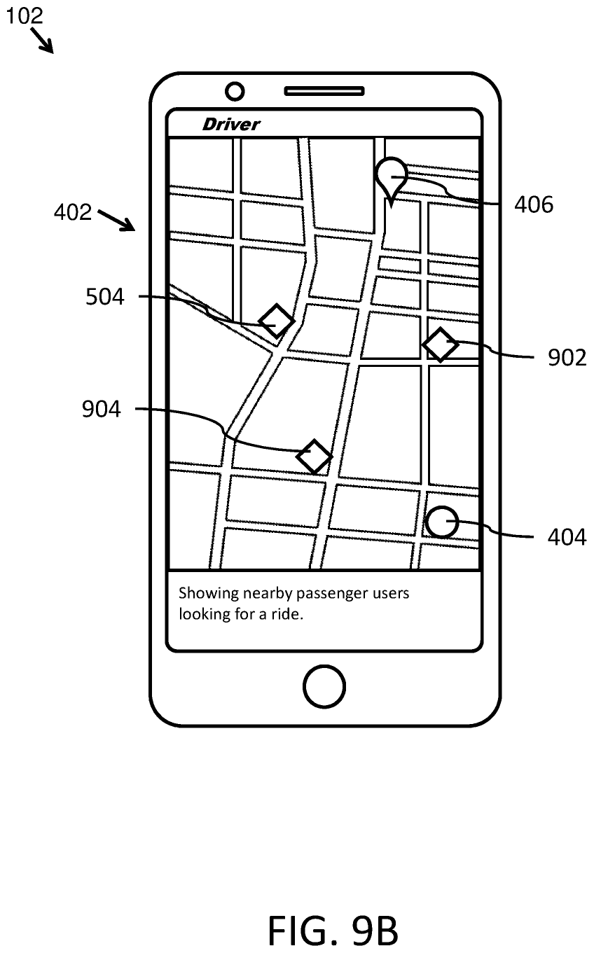

FIG. 9A depicts one embodiment of the driver user device 102. The driver user device 102 may receive the second rideshare data, which may include data indicating of the acceptance of the ride proposal 802. The acceptance may correspond to the passenger user device 104 that accepted the ride proposal 802. In response to receiving the second rideshare data, the driver user device 102 may modify displayed information to reflect the acceptance. For example, as depicted in FIG. 9A, in response to the passenger user device 104 corresponding to the passenger start location 504 accepting the ride proposal 802, the map 402 of the driver user device 102 may display the passenger start location 504 differently than other passenger start locations 902, 904 that have not accepted a ride proposal 802. Passenger start locations corresponding to accepted ride proposals 802 may be displayed with a different icon, a different color, or some other indication indicating that they have accepted a ride proposal 802. The driver user device 102 may display an acceptance message 906. The acceptance message 906 may include information about the passenger user such as the passenger user's name, the passenger start location address, or the passenger usage amount (estimated or adjusted).

In one embodiment, the second rideshare data may include data indicating the decline of the ride proposal 802. In response to receiving the second rideshare data that includes the decline data, the driver user device 102 may modify displayed information to reflect the decline. For example, in response to the passenger user device 104 corresponding to the passenger start location 504 declining the ride proposal 802, the map 402 of the driver user device 102 may display the passenger start location 504 differently than other passenger start locations 902, 904 that have accepted the ride proposal 802 or have not yet not accepted or rejected a ride proposal 802.

In some embodiments, the driver user device 102 may display other information. For example, the driver user device 102 may display a total passenger usage amount. The total passenger usage amount may include the sum of the passenger usage amounts (estimated or adjusted) of each passenger user that has accepted a ride proposal 802 from the driver user device 102. The map 402 may display the passenger route 604. The passenger route 604 may update in response to the driver user device 102 receiving further ride proposal 802 acceptances from other passenger user device 104. The updated passenger route 604 may include a route to multiple passenger start locations 504, 902, 904 and then to the driver destination 406.

FIG. 9B depicts one embodiment of the driver user device 102. In some embodiments, the map 402 may display the passenger start locations 504, 902, 904 even before the driver user selects a driver destination 406. For example, the driver user may open the ride share mobile application on his or her driver user device 102, and the driver user device 102 may display the map 402. The map 402 may display the driver start location 404 and may display one or more passenger start locations of nearby passenger users (including passenger start locations 504, 902, or 904). The passenger start locations of nearby passenger users may include the locations of the passengers user devices 104(1)-(n). The map 402 may, additionally or alternatively, display the driver start locations of other driver users. Similarly, in one embodiment, a passenger user device 104 may display a map 402 that may display the driver start location of one or more driver user devices 102 or passenger user devices 104(1)-(n) even before the passenger user of the passenger user device 104 selects a passenger destination 506.

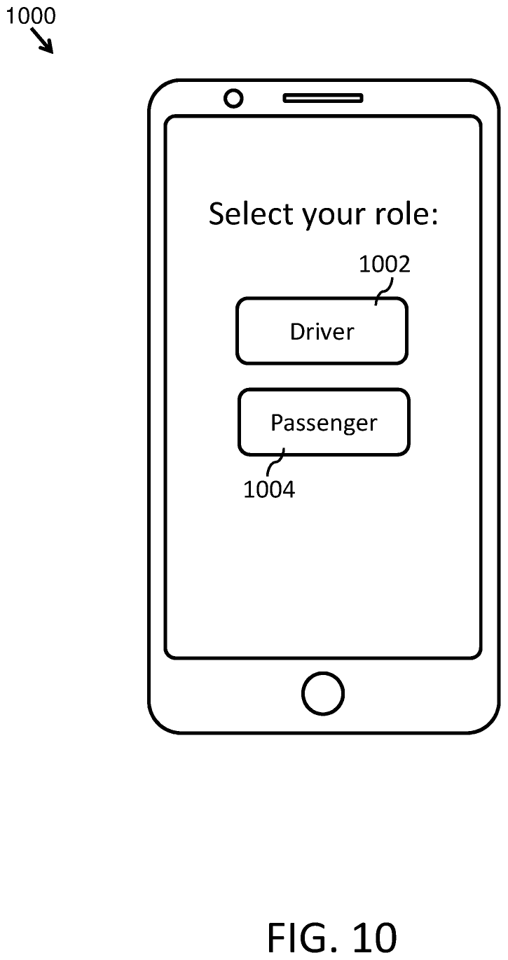

FIG. 10 depicts one embodiment of a user device 1000. The user device 1000 may include a driver button 1002 and a passenger button 1004. In response to the user of the user device 1000 selecting the driver button 1002, the user device 1000 may assume the role of a driver user device 102, and the driver user device 102 may send a driver role section to the server 108. In response to the user of the user device 1000 selecting the passenger button 1004, the user device 1000 may assume the role of a passenger user device 104, and the passenger user device 104 may send a passenger role selection to the server 108. In response to the user device 1000 receiving the selection from the user of the user device 1000, the user device 1000 may display the map 402 and may be ready to receive a selection of a location on the map 402 (e.g., a selection of the driver destination 406 or the passenger destination 506). In one embodiment, the method 200 may include receiving, over the data network 106, the driver role selection from the driver user device. The method 200 may include receiving, over the data network 106, the passenger role selection from the passenger user device.

In some embodiments, the method 200 may include receiving, over the data network 106, a confirmation from the driver user device 102 that a ride corresponding to the ride proposal 802 has begun. For example, the driver user of the driver user device 102 may select a button on the user interface of the driver user device 102 to start the ride. The driver user device 102 may send the confirmation to the server 108 to indicate the ride has begun. The server 108 may send notification data to each passenger user device 104 that has accepted a ride proposal 802 corresponding to the ride. The notification data may include a message indicating that the driver user is on his or her way to pick up the passenger user.

In one embodiment, the method 200 may include receiving, over the data network 106, a confirmation from the driver user device that the ride has ended. For example, the driver user of the driver user device 102 may select a button on the user interface of the driver user device 102 that the ride is over. The driver user device 102 may send the confirmation to the server 108 to indicate the ride has ended. The server 108 may initiate one or more post-ride processes. The one or more post-ride processes may include a passenger giving feedback or a rating corresponding to the ride (which may be used with the driver vetting data described herein), payment processing (discussed below), or other processes.

In one embodiment, the method 200 may include payment processing. The method 200 may include receiving, over the data network 106, a payment amount from the passenger user device 104. The payment amount may include an indication of how much the passenger user corresponding to the passenger user device 104 will pay the driver user. The method 200 may include charging, to the passenger user corresponding to the passenger user device 104, the payment amount. The 200 method may include making a payment to a driver user based on the payment amount. The driver user may correspond to the driver user device 102.

In one embodiment, the payment amount from the passenger user device 104 may include the estimated passenger usage amount (e.g., the estimated passenger usage amount that was calculated in step 208, or the estimated passenger usage amount 806 sent in the acceptance data from the passenger user device 104). In some embodiments, the payment amount may include the adjusted passenger usage amount that was entered by the passenger user in the area 816 of FIG. 8C.

The server 108 may receive the payment amount from the passenger user device 104. In some embodiments, the server 108 may associate payment information (e.g., an internal account balance, debit or credit card information, bank account information, cryptocurrency wallet addresses, etc.) with driver or passenger user accounts. The driver or passenger user accounts may be stored by the server 108 or by a computer system associated with the server 108. For example, the data storage 116 of the server 108 may store the user account data. The server 108 may charge the payment amount to the passenger user of the passenger user device 104. For example, the server 108 may store an internal balance of the passenger user, and charging the payment amount to the passenger user may include reducing that passenger user's internal balance by the payment amount. In another example, the server 108 may use a passenger user's credit card information to charge the passenger user's credit card for the payment amount. The server 108 may make a payment to the driver user based on the payment amount by increasing the driver user's internal account balance by the payment amount or by depositing the payment amount into a bank account of the driver user. In some embodiments, the payment module 114 may perform at least some of the payment processing.

The following is one example of a ride sharing instance of the ride sharing mobile application. A first user may select the driver button 1002 on his or her user device 1000. The first user's user device 1000 may assume the role of a driver user device 102. A second user may select the passenger button 1004 on his or her user device 1000. The second user's user device 1000 may assume the role of a first passenger user device 104(1). A third user may select the passenger button 1004 on his or her user device 1000. The third user's user device 1000 may assume the role of a second passenger user device 104(2).

The driver user device 102 may use GPS functionality of the driver user device 102 to determine a driver start location 404. The driver user device 102 may receive a selection of a driver destination 406 on the map 402 from the driver user. The driver destination 406 may include a local sports stadium. The driver user device 102 may receive a selection of a future time. The future time may include one hour before a sporting event occurring at the local sports stadium. The driver user device 102 may send driver input data to the server 108, and the driver input data may include the driver destination 406 and the future time. The server may receive the driver input data as part of the step 202 of the method 200.

The first passenger user device 104(1) and the second passenger user device 104(2) may each receive a selection of a passenger destination 506 on the map 402 from their respective passenger users. Each of the passenger destinations 506 may include the local sports stadium. Each passenger user device 104(1)-(2) may receive a selection of a future time. The future time may include 45 minutes before the sporting event occurs at the local sports stadium. Each passenger user device 104(1)-(2) may send their respective passenger input data to the server 108 as part of the step 204 of the method 200. Each passenger input data may include the passenger destination 506 and the future time.

The server 108 may receive 202 the driver input data and may receive 204 the passenger input data. The server 108 may determine 206 whether the driver input data and the passenger input data satisfy a predetermined criteria. The predetermined criteria may include that the driver destination 406 and the passenger destinations 306 match, that the future times be within 30 minutes of each other, and that a passenger route 604 for each passenger user does not add more than 2 miles (approx. 3.2 km) to the driver route 602. The server 108 may determine that the passenger input data from the first passenger user device 104(1) satisfies the predetermined criteria, but that the passenger input data from the second passenger user device 104(2) does not.

The server 108 may calculate 208 the estimated passenger usage amount for the second passenger user device 104(1). The server 108 may determine that the second passenger user sharing the ride with the driver user will add 1.5 miles (approx. 2.4 km) to the driver route 602. The server 108 may determine (from data stored by the server 108) that the driver user's vehicle has a fuel efficiency of 20 MPG (approx. 8.5 KPL). The server 108 may determine that fuel cost for the area of the ride is $2.50 per gallon (approx. $0.66 per liter). Thus, the added fuel cost for the second passenger user may include $0.19. The server 108 may determine that the cost-per-distance unit is $0.50 per mile (approx. $0.31 per km). Thus, the added cost-per-distance unit for the second passenger user may include $0.75. The server 108 may determine that parking for the sporting event costs $25. thus the second passenger's share of the parking cost may include $12.50. Thus, the estimated passenger usage amount for the second passenger user may include $0.19+$0.75+$12.50=$13.44. The server 108 may send 210 first rideshare data to the driver user device 102. The first rideshare data may include data indicating a location of the passenger user device 104 (e.g., the passenger start location 504), data indicating the future time provided by the passenger user, or data indicating the estimated passenger usage amount.

The driver user device 102 may display passenger information 702 corresponding to the passenger user of the first passenger user device 104(1). The passenger information 702 may include the passenger start location 704 and the estimated passenger usage amount 706 of $13.44. The map 402 of the driver user device 102 may display the passenger start location 504 of the first passenger user. The driver user may select the passenger start location 504 on the map 402. The driver user may select the button 708, and the driver user device 102 may send selection data to the server 108. The selection data may include data indicating a selection of the passenger user device 104(1).

The server 108 may receive 212 the selection data from the driver user device 102. The server 108 may send 214 ride proposal data to the first passenger user device 104(1). The ride proposal data may include the estimated passenger usage amount of $13.44. The ride proposal data may also include data indicating the driver start location 404, the time the driver user is leaving the driver start location 404, or other data.

The passenger user device 104(1) may receive the proposal data and display a portion of the proposal data as a ride proposal 802. The ride proposal 802 may include the driver start location 804 and the estimated passenger usage amount 806. The map 402 may display the driver start location 404. The first passenger user may select the accept button of the one or more buttons 808 to accept the ride proposal 802. The passenger user device 104(1) may send acceptance data corresponding to the ride proposal 802 to the server 108. The acceptance data may include data indicating an acceptance corresponding to the ride proposal 802. The server 108 may receive 216 the acceptance data. The server 108 may send 218 second rideshare data to the driver user device 102. The second rideshare data may include data indicating the acceptance of the ride proposal 802.

When the future time arrives, the driver user may follow the passenger route 604 to pick up the second passenger user and take both the driver user and the second passenger user to the local sports stadium. At the end of the ride, the second passenger user may use his or her passenger user device 104(1) to select a payment amount of $16.00 (the $13.44 estimated passenger usage amount plus a $2.56 tip) and send the payment amount to the server 108. The server 108 may use credit card information associated with the second passenger user to charge a credit card of the second passenger user for the payment amount. The server 108 may user bank account information associated with the driver user to deposit the payment amount in a bank account of the driver user. The server 108 may deduct a fee from the payment amount before depositing the remaining amount in the bank account of the driver user.

In some embodiments, the passenger user device 104 may send ride cancellation data to the server 108. The ride cancellation data may include data indicating that the passenger user of the passenger user device 104 no longer wishes to participate in a previously accepted ride. In response, the server 108 may send at least a portion of the ride cancellation data to the driver user device 102 corresponding to the previously accepted ride. The ride cancellation data sent to the driver user device 102 may include an updated passenger route 604 to the driver user device 102. The updated passenger route 604 may remove the passenger start location 504 of the passenger user device 104 that sent the cancellation.

In one embodiment, the driver user device 102 may send ride cancellation data to the server 108. The ride cancellation data may include data indicating that the driver user of the driver user device 102 no longer wishes to participate in a previously proposed ride. In response, the server 108 may send at least a portion of the ride cancellation data to the one or more passenger user devices 104(1)-(n) corresponding to the previously proposed ride.

In some embodiments, a ride shared by the driver user and the one or more passenger users may include a round trip ride. The round trip ride may include the passenger route 402 to the driver destination 406 and a return route. The return route may include a route from the driver destination 406 to the one or more passenger start locations 304, 902, 904 and then to the driver start location 404. Alternatively, the return route may include a route from the driver destination 306 to one or more alternate passenger drop off locations, and then to the driver start location 404. In another alternative embodiment, the return route may include a route from a meeting location for the driver user and one or more passenger users to the one or more passenger start locations 304, 902, 904 or alternate passenger drop off locations, and then to the driver start location 404. In some embodiments, the estimated passenger usage amount for each passenger user include an estimated passenger usage amount for the round trip.

In one embodiment, the driver user of the driver user device 102 may contact a passenger user of the passenger user device 104 to propose a ride via a short message service (SMS) message, an email, a phone call, or via another communication method. The passenger user may accept the proposed ride via a similar communication method. In response, the driver user may add the passenger user to the passenger route 604 manually using the driver user device 102 (e.g., by selecting the passenger start location 504 on the driver user device 102 and selecting an option to add the passenger user to the passenger route 604).

In one or more embodiments, a driver user device 102 or passenger user device 104(1), referred to as the “initiating device” may include an emergency broadcast functionality. In one embodiment, the emergency broadcast functionality may allow the initiating device to broadcast an emergency message to one or more other driver user devices 102 or passenger user devices 104(2)-(n), referred to as the “other devices.” Additionally or alternatively, the emergency broadcast functionality may allow the initiating device to see the locations of the one or more other devices. In either case, the other devices may include other devices within a threshold distance of the initiating device. The server 108 may send the locations of the one or more other devices to the initiating device, or the server 108 may send the location and emergency message of the initiating device to the one or more other devices. The emergency message may include information about an emergency situation. The emergency situation may include a vehicle accident, a crime, or some other emergency or dangerous situation. The initiating device may view the locations of the one or more other devices on the map 402. The one or more other devices may view the location of the initiating device on the map 402.

In one embodiment, one or more third-party services may integrate with the ride sharing mobile application. A third-party service may include a third-party server, website, computer platform, application, software, or similar service. A third-party service may include the social networking platform 118, a calendar application, an address book application, or another third-party service. The ride sharing mobile application integrating with the social networking platform 118 may include connecting an account on the social networking platform 118 with the ride sharing mobile application of the user of the driver user device 102 or passenger user device 104. The ride sharing mobile application may receive data from a third-party service. For example, the ride-sharing mobile application may receive contact data from an address book application or the social media platform 118 so a user may contact people in the contact data through the ride sharing mobile application. The ride sharing mobile application may send data to a third-party service. For example, a driver user may schedule a ride, and the ride sharing mobile application may send data about the scheduled ride to a calendar application so the scheduled ride appears in the calendar. The ride sharing mobile application may share data with third-party services in other ways.

In one embodiment, a third-party service may include a vetting service. A vetting service may include a service that stores or makes available information that driver users or passenger users may wish to know about other driver or passenger users. In some embodiments, a vetting service may include a background-checking service or a criminal registry (such as a sex offender registry). A vetting service may include a review service. The review service may allow users to rate a driver or passenger user (e.g., between one and five stars) or leave comments about the driver or passenger user. The vetting service may include a social networking service (e.g., the social media platform 118) that may allow a user of the ride sharing mobile application to view information stored by the social networking service about the driver or passenger user (e.g., a passenger user may view a social media profile of a driver user so that when the driver user arrives to pick up the passenger user, the passenger user can compare the driver user to photos on the social media profile). In some embodiments, the passenger vetting data 712 or the driver vetting data 812 may link to a vetting service.

In some embodiments, the ride sharing mobile application may include links to the one or more vetting services. A driver or passenger user may select a link and the ride sharing mobile application may display information received from a location associated with the link, or the user device may launch another application (e.g., a web browser) to display the information. In one embodiment, the server 108 may seek out and aggregate data (e.g., using a web crawler or other data-aggregating functionality) from third-party services about a driver user or a passenger user for use as driver or passenger vetting data. As mentioned above, the passenger information 702 or the ride proposal 802 may include functionality to display the vetting data. For example, a user selecting a portion of the passenger information 702 or the ride proposal 802 on the user's device 102 or 104 may cause the user device 102 or 104 to display the vetting data or a link to the third-party service.

In some embodiments, the ride sharing mobile application may include an option for an entity to customize the application for its own use. Customizing the application may include the application displaying the entity's logo on a screen of the driver user device 102 or the passenger user device 104. Customizing the application may include that the predetermined criteria includes that the driver user and the one or more passenger users are members of the entity. In other words, when a driver user device 102 is using the ride sharing mobile application as customized by an entity, the driver user device 102 only receives passenger start locations 304 of passenger users that are also members of the entity. As an example, an employer may customize the ride sharing mobile application for its own use. Employees of the employer may use the customized ride sharing mobile application. A driver user device 102 running the customized ride sharing mobile application may receive the first rideshare data, and the first rideshare data may include data indicating a location of a passenger user device, and the passenger user device may belong to a user that is also an employee of the employer.

In one embodiment, at least a portion of the ride sharing mobile application functionality described herein may apply to a rental sharing mobile application. The rental sharing mobile application may allow a first user to notify other users that the first user has entered into a rental arrangement and is willing to share in the use of the rental in exchange for the other users donating to the renting user. The rental may include the rental of a vehicle (such as a car, boat, recreational vehicle, etc.), equipment (such as yard care equipment, painting equipment, construction equipment, etc.), a facility (such as a banquet hall, reception center, convention center, etc.), or some other thing that can be rented.

In one or more embodiments, a user of the driver user device 102 may generate a rental event. The rental event may appear on the map 402. The rental event may be similar to the driver destination 406. The rental event may appear on the map 402 of one or more passenger user devices 104(1)-(n). The rental event may include a location (similar to the address 806), an estimated passenger usage amount 806, or other information (such as a date and time, the thing being rented, or a capacity of the rental). In some embodiments, the user of the driver user device 102 may select which passenger users to send the rental event to. In some embodiments, the rental event may appear on the map 402 of one or more passenger user device 104(1)-(n) without the driver user selecting those passenger users. One or more passenger users may accept a rental event (similar to a passenger user accepting a ride proposal 802). The one or more passenger users that accept the rental event may pay the driver user via payment processing, similar to the payment processing described herein.

As an example of a rental sharing mobile application, a first user may rent a speed boat. The first user may determine that he or she has room on the boat for additional passengers. The first user may use the rental sharing mobile application to generate a rental event. The rental event may appear on the map 402. Other users may see the rental event appear on the map 402 of the rental sharing mobile application on their user devices. The other users may select the rental event on their map 402 to view information about the rental event. If another user wishes to participate in the rental, the user may accept the rental event and engage in payment processing to contribute a contribution estimated amount 804 to the first user. The first user may be notified of the acceptance of the rental event by one or more other users.

In some embodiments, the ride sharing mobile application of the disclosure provides one or more benefits. For example, the ride sharing mobile application may reduce the number of vehicles in use simultaneously, which may reduce traffic and pollution. The ride sharing mobile application may provide an easy and convenient way for driver users and passenger users to determine who is going to similar destinations at similar times, coordinate rides to those destinations, calculate passenger usage amounts for the driver users, or process payments to the driver users.

While the making and using of various embodiments of the present disclosure are discussed in detail herein, it should be appreciated that the present disclosure provides many applicable inventive concepts that are embodied in a wide variety of specific contexts. The specific embodiments discussed herein are merely illustrative of specific ways to make and use the invention and do not delimit the scope of the invention. Those of ordinary skill in the art will recognize numerous equivalents to the specific apparatus and methods described herein. Such equivalents are considered to be within the scope of this invention and may be covered by the claims.

Furthermore, the described features, structures, or characteristics of the disclosure may be combined in any suitable manner in one or more embodiments. In the description contained herein, numerous specific details are provided, such as examples of programming, software, user selections, hardware, hardware circuits, hardware chips, or the like, to provide understanding of embodiments of the disclosure. One skilled in the relevant art will recognize, however, that the disclosure may be practiced without one or more of the specific details, or with other methods, components, materials, and so forth. In other instances, well-known structures, materials, or operations may not be shown or described in detail to avoid obscuring aspects of the disclosure.

These features and advantages of the embodiments will become more fully apparent from the description and appended claims, or may be learned by the practice of embodiments as set forth herein. As will be appreciated by one skilled in the art, aspects of the present disclosure may be embodied as an apparatus, system, method, computer program product, or the like. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present disclosure may take the form of a computer program product embodied in one or more computer-readable medium(s) having program code embodied thereon.

In some embodiments, a module, such as the determination module 110, donation module 112, or payment module 114, may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules, such as the determination module 110, donation module 112, or payment module 114, may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer-readable medium(s).

In some embodiments, a module may include a smart contract hosted on a blockchain. The functionality of the smart contract may be executed by a node (or peer) of the blockchain network. One or more inputs to the smart contract may be read or detected from one or more transactions stored on or referenced by the blockchain. The smart contract may output data based on the execution of the smart contract as one or more transactions to the blockchain. A smart contract may implement one or more methods or algorithms described herein.

The computer program product may include a computer-readable storage medium (or media) having computer-readable program instructions thereon for causing a processor to carry out aspects of the present disclosure. The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium may include a portable computer diskette, a hard disk, a random access memory (“RAM”), a read-only memory (“ROM”), an erasable programmable read-only memory (“EPROM” or Flash memory), a static random access memory (“SRAM”), a hard disk drive (“HDD”), a solid state drive, a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations or block diagrams of methods, apparatuses, systems, algorithms, or computer program products according to embodiments of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flow chart diagrams included herein are generally set forth as logical flow chart diagrams. As such, the depicted order and labeled steps are indicative of one embodiment of the presented method. Other steps and methods may be conceived that may be equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

Thus, although there have been described particular embodiments of the present invention of new and useful INTEGRATED SOCIAL NETWORKING MOBILE APPLICATION WITH RIDE SHARING PROGRAM, it is not intended that such references be construed as limitations upon the scope of this invention.

What is claimed is:

1. A computer-implemented method for a ride-sharing mobile application, comprising:
receiving, over a data network, driver input data from a driver user device, wherein the driver input data includes data indicating a driver destination;
receiving, over the data network, passenger input data from a passenger user device, wherein the passenger input data includes data indicating a passenger destination;
determining that the driver input data and the passenger input data satisfy a predetermined criteria based on, at least in part, the driver destination corresponding to the passenger destination;
calculating an estimated passenger usage amount for the passenger user device;
sending, over the data network, first rideshare data to the driver user device, wherein the first rideshare data includes
data indicating a location of the passenger user device, and
data indicating the estimated passenger usage amount;
receiving, over the data network, selection data from the driver user device, wherein the selection data includes data indicating a selection of the passenger user device;
sending, over the data network, ride proposal data to the passenger user device, wherein the ride proposal data includes data indicating the estimated passenger usage amount;
receiving, over the data network, acceptance data from the passenger user device, wherein the acceptance data includes data indicating an acceptance, from the passenger user device, corresponding to the ride proposal data; and
sending, over the data network, second rideshare data to the driver user device, wherein the second rideshare data includes data indicating the acceptance from the passenger user device.

2. The computer-implemented method of claim 1, wherein:
the data indicating the driver destination comprises at least of one an address, or global positioning system (GPS) coordinates; and
the data indicating the passenger destination comprises at least of one an address, or GPS coordinates.

3. The computer-implemented method of claim 1, wherein:
the predetermined criteria comprises a passenger route being within a distance variance threshold of a driver route;
the driver route includes a first route from a driver start location to the driver destination; and
the passenger route includes at least one of
a second route from the driver start location to the location of the passenger user device to the driver destination,
a third route from the driver start location to the location of the passenger user device to the passenger destination to the driver destination, or
a fourth route from the location of the passenger user device to the passenger destination.

4. The computer-implemented method of claim 3, wherein calculating the estimated passenger usage amount is based on, at least in part, at least one of:
an added distance corresponding to the passenger route; and
a cost-distance analysis of the passenger route.

5. The computer-implemented method of claim 3, wherein calculating the estimated passenger usage amount is based on a fuel-efficiency of a vehicle of a passenger user.

6. The computer-implemented method of claim 1, wherein calculating the estimated passenger usage amount is based on an extra amount comprising at least one of:
a parking fee;
an entrance fee; or
a toll.

7. The computer-implemented method of claim 1, wherein:
the acceptance data further includes an adjusted passenger usage amount different from the estimated passenger usage amount; and
the second rideshare data further includes data indicating the adjusted passenger usage amount.

8. The computer-implemented method of claim 7, wherein the adjusted passenger usage amount includes the estimated passenger usage amount plus an upcharge amount.

9. The computer-implemented method of claim 1, further comprising:
receiving, over the data network, a confirmation from the driver user device that a ride corresponding to the ride proposal data has begun,
receiving, over the data network, a confirmation from the driver user device that the ride has ended.

10. The computer-implemented method of claim 1, wherein:
the first rideshare data further includes first vetting data corresponding to a passenger user of the passenger user device; and
the ride proposal data further includes second vetting data corresponding to a driver user of the driver user device.

11. The computer-implemented method of claim 10, wherein:
the first vetting data includes a link to a social media profile of the passenger user on a first social networking platform; and
the second vetting data includes a link to a social media profile of the driver user on a second social networking platform.

12. An apparatus for a ride-sharing mobile application, comprising:
at least one processor; and
a non-transitory computer-readable storage medium including program instructions, wherein the at least one processor, in response to executing the program instructions, is configured to:
receive, over a data network, driver input data from a driver user device, wherein the driver input data includes data indicating a driver destination;
receive, over the data network, passenger input data from a passenger user device, wherein the passenger input data includes data indicating a passenger destination;
determine that the driver input data and the passenger input data satisfy a predetermined criteria based on, at least in part, the driver destination corresponding to the passenger destination;
calculate an estimated passenger usage amount for the passenger user device;
in response to determining that the driver input data and the passenger input data satisfy the predetermined criteria, send, over the data network, first rideshare data to the driver user device, wherein the first rideshare data includes
data indicating a location of the passenger user device, and
data indicating the estimated passenger usage amount,
receive, over the data network, selection data from the driver user device, wherein the selection data includes data indicating a selection of the passenger user device;
send, over the data network, ride proposal data to the passenger user device, wherein the ride proposal data includes data indicating the estimated passenger usage amount;
receive, over the data network, acceptance data from the passenger user device, wherein the acceptance data includes data indicating an acceptance, from the passenger user device, corresponding to the ride proposal data; and
send, over the data network, second rideshare data to the driver user device, wherein the second rideshare data includes data indicating the acceptance from the passenger user device.

13. The apparatus of claim 12, wherein the predetermined criteria comprises the passenger route being within a time variance threshold of the driver route.

14. The apparatus of claim 12, wherein the ride proposal data further includes data indicating a future time.

15. The apparatus of claim 12, wherein the at least one processor is further configured to:
receive, over the data network, a driver role selection from the driver user device; and
receive, over the data network, a passenger role selection from the passenger user device.

16. A system for a ride-sharing mobile application, comprising:
a driver user device, wherein the driver user device is configured to send, over a data network, driver input data, and wherein the driver input data includes data indicating a driver destination;
a passenger user device, wherein the passenger user device is configured to send, over the data network, passenger input data, and wherein the passenger input data includes data indicating a passenger destination; and
at least one computer server, wherein the at least one computer server is in data communication with the driver user device and the passenger user device over the data network, and wherein the at least one computer server is configured to
receive the driver input data and the passenger input data,
determine that the driver input data and the passenger input data satisfy a predetermined criteria based on, at least in part, the driver destination corresponding to the passenger destination,
calculate an estimated passenger usage amount for the passenger user device,
generate passenger route data based, at least in part, on the driver destination and the passenger destination, wherein the passenger route data includes a route from a driver start location to a location of the passenger user device to the driver destination, and
sending, over the data network, first rideshare data to the driver user device, wherein the first rideshare data includes
data indicating the location of the passenger user device,
the passenger route data, and
data indicating the estimated passenger usage amount.

17. The system of claim 16, wherein the driver user device is further configured to:
receive the first rideshare data from the at least one computer server over the data network;
display, on a display screen of the driver user device, at least a portion of the passenger route data and the estimated usage amount;
generate selection data, wherein the selection data includes data indicating a selection, by a driver user of the driver user device, of the passenger user device; and
send the selection data to the at least one computer server over the data network.

18. The system of claim 17, wherein:
the at least one computer server is further configured to send, over the data network, ride proposal data to the passenger user device;
the ride proposal data includes the estimated passenger usage amount; and
the ride proposal data includes at least a portion of the passenger route data.

19. The system of claim 18, wherein the passenger user device is further configured to:
receive, over the data network, the ride proposal data from the at least one computer server;
display, on a display screen of the passenger user device, at least a portion of the passenger route data;
generate acceptance data, wherein the acceptance data includes
data indicating an acceptance, from the user of the passenger user device, corresponding to the ride proposal data, and
an adjusted passenger usage amount; and
sending the acceptance data to the at least one computer server.

20. The system of claim 19, wherein the at least one computer server is further configured to:
receive, over the data network, the acceptance data from the passenger user device; and
send, over the data network, second rideshare data to the driver user device, wherein the second rideshare data includes
data indicating the acceptance from the passenger user device, and
data indicating the adjusted passenger usage amount.
